(19) United States
(12) Patent Application Publication
(10) Pub. No.: US 2026/0128688 A1
(43) Pub. Date: May 7, 2026

(54) KINETIC ENERGY HARVESTING SYSTEM

(71) Applicant: COLE FRANKLIN, SAN CLEMENTE, CA (US)

(72) Inventor: COLE FRANKLIN, SAN CLEMENTE, CA (US)

(21) Appl. No.: 19/042,916

(22) Filed: Jan. 31, 2025

Related U.S. Application Data
(60) Provisional application No. 63/717,147, filed on Nov. 6, 2024.
(60) Provisional application No. 63/742,723, filed on Jan. 7, 2025.

(51) Int. Cl. H02N 11/00

(52) U.S. Cl. CPC H02N 11/002

(57) ABSTRACT

A kinetic energy harvesting system includes an air intake accelerator. The air intake accelerator is formed as a funnel which receives an airflow. A plasma generator receives the airflow from the air intake accelerator and generates a plasma flow. An inductor current section generates electricity from the plasma flow. The sensor system further includes a plasma sensor. The plasma sensor senses a speed and temperature of the plasma flow. The inductor current section further includes multiple metal wires mounted in the plasma flow. The multiple metal wires generate induction electricity from the plasma flow.

The present invention claims priority to two provisional applications by the same inventor, namely U.S. Ser. No. 63/717,147 filed Nov. 6, 2024 entitled Wind Alternator and U.S. Ser. No. 63/742,723 filed Jan. 7, 2025 entitled Kinetic Energy Harvesting for Electric Vehicles the disclosures of which are incorporated herein by reference.

### TECHNICAL FIELD

The present disclosure relates to a kinetic energy harvesting system.

### DISCUSSION OF RELATED ART

A variety of different kinetic energy harvesting systems have been described in the prior art. For example, in U.S. Pat. No. 7,652,389 entitled “Air-Wind Power System for A Vehicle” by Clint Farmer published Jan. 26, 2010, the abstract discloses, “The present invention provides an air-wind power system for a vehicle having an electrically operable drive system. The system includes at least one battery which is mounted within an interior portion of such vehicle and which is connected to such drive system and at least one air-wind powered turbine which is mounted on the vehicle and which is electrically coupled to at least one battery. The air-wind powered turbine has a propeller fixed in a vertical plane and mounted on a horizontally disposed shaft having an axis thereof being disposed perpendicular to a longitudinal axis of such vehicle. A rotational movement of the propeller caused by an air current enables the at least one turbine to generate an electric energy which is stored in the at least one battery and which is used by such drive system to move such vehicle in a direction of travel”.

For example, in United States publication number US20110266075 entitled “Energy Generation System for Electric, Hybrid, and Conventional Vehicles” by Harry L. Guzelimian published Nov. 3, 2011, the abstract discloses, “The vehicle electrical energy generation system which employs one or a plurality of fans operatively engaged with a generator or alternator to generate electrical power. Incoming wind moves past fans engaged to rotate alternators or generators and exits to a secondary conduit as moving air. The moving air is directed to one or a plurality of conduits leading to one or a plurality of moving-air employing components from a group including, a de-fogging component, a windshield defroster, a windshield de-icing component, a wind powered windshield wiper, a passenger heating system, a battery heating component, and a battery cooling compartment”.

For example, in United States publication number US20220314829 entitled “Renewable and Environment Friendly Wind Powered Vehicle System” by Kuzhangaira et al. published Oct. 6, 2022, the abstract discloses, “The present invention relates to a wind powered, electrical power generating system for vehicles. The system uses inexhaustible and clean wind energy to produce electrical power for an electric vehicle. The system includes at least one wind turbine positioned to capture wind and coupled to an electromechanical generator for converting the wind into electrical power. The electrical power produced by the generator is stored in a battery pack, for providing electrical power to the DC motor of the vehicle. The battery pack includes three batteries, which either provide power to the DC motor, or are recharged by the generator, depending on their respective power levels. An auto change component swaps the first battery for the second battery, when the power level of the first battery falls below a predefined threshold value”.

For example, in United States publication number US20210122249 entitled “Wind Based Electrical Generation System for Vehicles” by Maury et al. published Apr. 29, 2021, the abstract discloses, “The present invention relates to wind-based generation of electrical energy. By providing small individual generation units that can be combined to have inputs at one or more wind pressure peak areas on a vehicle and outlets at low pressure locations on a vehicle, it is possible to contribute substantial amounts of wind-generated electricity for powering the vehicle without creating equivalent offsetting aerodynamic drag”.

For example, in United States publication number US20100237627 entitled “Vehicle Mounted Wind Powered Hydrogen Generator” by Socolove et al. published on Sep. 23, 2010, the abstract discloses, “A vehicle mounted wind powered generator has a self-contained housing with an open, forward airflow intake section and a rear airflow exhaust section. The housing is configured to be mounted on the roof of a vehicle by conventional mounting supports. Airflow is directed into the housing where it is constricted in order to increase the airflow velocity past one or more wind turbines. The airflow is then directed through a channel within the housing and is ultimately discharged through the exhaust section. Power generated by the wind turbines is used to create electricity by means of an attached electricity-generating device, e.g. an alternator/generator. The electricity produced operates a hydrogen production system having its components located within the housing of the hydrogen generator. The resultant hydrogen gas is directed to the engine of the vehicle to increase its efficiency and reduce its emissions”. As can be seen from the general prior art, wind turbines mounted to a vehicle can recover and harvest kinetic energy.

### SUMMARY OF THE INVENTION

A kinetic energy harvesting system includes an air intake accelerator. The air intake accelerator is formed as a funnel which receives an airflow. A plasma generator receives the airflow from the air intake accelerator and generates a plasma flow. An inductor current section generates electricity from the plasma flow. The sensor system further includes a plasma sensor. The plasma sensor senses a speed and temperature of the plasma flow. The inductor current section further includes multiple metal wires mounted in the plasma flow. The multiple metal wires generate induction electricity from the plasma flow.

The multiple metal wires are parallel to the plasma flow. The air intake accelerator has a magnetic check valve. The controller and sensor system controls the plasma generator. The sensor system senses a speed of the plasma flow and temperature in the inductor current section. The sensor system includes an air intake sensor and an air outlet sensor. The air intake sensor senses an intake air flow speed and an intake air flow temperature. The air outlet sensor senses an outlet airflow speed and an outlet airflow temperature. The plasma generator has a plasma generation matrix is formed from a plurality of negative charge elements and positive charge elements that are charged to produce plasma.

### BRIEF DESCRIPTION OF THE DRAWINGS

FIG. 1 is a schematic diagram according to an air discharge wireframe and ion capture embodiment of the present invention.

FIG. 2 is a diagram of the air discharge wireframe and ion capture embodiment of the present invention.

FIG. 3 is a diagram of the air intake of an automotive vehicle.

FIG. 4 is a diagram of an exhaust of an automotive vehicle.

FIG. 5 is a diagram of the air intake accelerator, plasma generator and inductor current embodiment of the present invention.

The following call out list of elements can be a useful guide in referencing the element numbers of the drawings.
21 Air Intake Opening
22 Airflow Intake
23 Airflow Exit
24 Airflow Exit Opening
25 Air Channel Profile
26 Air Channel
27 Air Inlet Funnel
28 Inlet Air Damper
29 Proton Capture Coil Mount
31 Proton Capture Coil
32 Proton Capture First Lead Wires
33 Proton Capture Second Lead Wires
34 Air Discharge Wire Frame
35 Electrical Ground
36 Funnel Constriction
37 Air Discharge Wire Frame Mount
38 Negative Charge
40 Electron Capture Plate
41 Electron Capture Plate Coil Windings
42 Porous Ion Capture Mesh
43 Negative Ions
44 Generator
45 Transformer
45 Airflow Exit Sensor
47 Plasma Sensor
46 Airflow Intake Sensor
48 Controller
51 Vehicle Front
52 Vehicle Rear
53 First Funnel Section
54 Second Funnel Section
55 Third Funnel Section
155 Magnetic Check Valve
56 Plasma Generator
57 Plasma Stream
58 Induction Wire Element
59 Induction Chamber
61 High Speed Air Flow Section
62 Positive Charge Wire
63 Negative Charge Wire
64 Plasma Generation Matrix
65 Plasma Generation Chamber
66 Airflow Exit Conductor
88 Battery

### DETAILED DESCRIPTION OF THE EMBODIMENTS

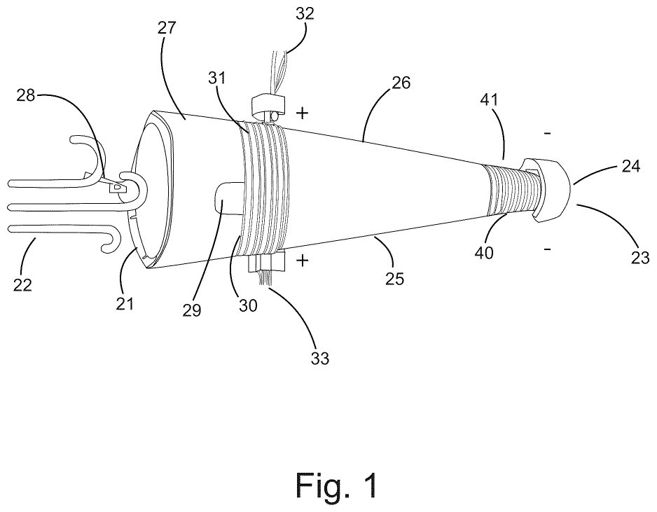

As shown in FIG. 1, the present invention intakes air on a vehicle to harvest the kinetic energy for the vehicle. The vehicle can be an electric vehicle or a vehicle that receives and uses electrical power. A wind alternator can generate 1000 Watts at 80 miles per hour which can be applicable for electric cars and buses and trucks. The hybrid power system can also be used for combining wind and solar energy for off grid or grid connected applications. Electric aircraft can also benefit from in-flight power generation for reducing weight and increasing efficiency. Marine and Aerospace applications can also benefit from kinetic energy harvesting.

A key feature of the present invention is the use of plasma for recovering high current power from kinetic energy. The object of the invention is to improve electric vehicles by extending range, and reducing global carbon emissions. Kinetic energy recovery can reduce charging frequency and extend range. Air intake can generate electricity. An air intake first passes through an air channel. The air channel is mounted to a vehicle or formed as a part of a vehicle housing. The air channel receives a flow of air.

A first method of generating electricity from the airflow is plasma generation with proton capture and recombination to produce electricity. The wind generated electricity accelerates the atmospheric ion and electron plasmas to increase the current flow. The discharged protons are captured on a metal mesh and allow pass-through of the electron charge particles size to create a high-voltage positive discharge. The electron and proton capture will result in the generation of a significant amount of power. A wire matrix which breaks down air into plasma ions. The plasma ions provide a reduced dielectric discharge design.

A dielectric element then captures positive charge, allowing electrons to flow through and generate power. The vehicle motion thus generates current power proportional to the vehicle speed. The plasma channel can be formed as an ion acceleration tube. An ignition system such as a 12V spark plug or ignition chamber operating at 100 miles an hour can ignite the plasma. The plasma can travel at 1000 mi./h and in a one-inch tube can have a duration of 0.344 milliseconds. A square ignition chamber of approximately 4 inch width passes to a transition tube of approximately 2 inches in diameter which then passes to a plasma acceleration tube of one-inch diameter which is 4 feet long.

The electric discharge or electric arc between two electrodes is a function of pressure and gap length that can be determined according to Paschen's law. Biased voltage using DC or rf frequencies may optimize the discharge rate. For atmospheric based systems it is preferable to increase the wind pressure near the point of discharging air with a decrease in pressure on the exit adding time to mitigate recombination. If used in low atmospheric environments, such as in space, adding water vapor may be required for the unit to continue working.

The air inlet funnel 27 receives air from the air intake opening 21. The air intake opening 21 receives and airflow intake 22 when the inlet air damper 28 is opened. The controller can open and close the air inlet damper 28. The proton capture coil 31 can be mounted on a proton capture coil mount 29. The proton capture shield 30 can capture protons and produce an electrical voltage across a proton capture first lead wires 32 and proton capture second lead wires 33. The positive charge of the proton capture shield is retained before the electron capture plate 40.

The air channel 26 has a narrowing funnel shape air channel profile 25. As the funnel narrows, the electron capture plate 40 receives electrons and crates a negative charge at an electron capture plate coil winding 41. The plasma then exits the airflow exit opening 24 at the airflow exit 23.

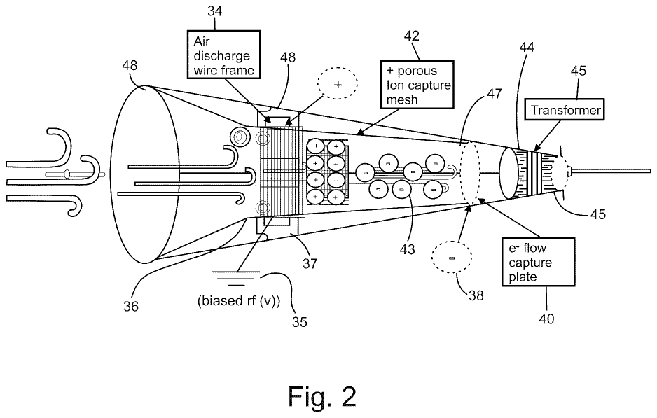

As shown in FIG. 2, an air discharge wireframe can have biased radiofrequency applied to it for generating electric discharge. A positive porous ion capture mesh can then recover the ions and then the negative flow capture plate can capture the negative ions. The difference between the positive and negative ions can produce an electric current.

The airflow intake can receive an airflow intake sensor 46 for monitoring air speed, temperature and pressure at the airflow intake. The funnel constriction 36 increases airflow speed through an air discharge wireframe 34. The air discharge wireframe preferably has an electrical ground 35. The air discharge wireframe 34 can be connected to an air discharge wireframe mount 37 so that is mounted to the funnel constriction 36. The air discharge wireframe mount 37 may further include wiring which allows positive and negative charge to be applied to the air discharge wireframe 34. The air discharge wireframe produces plasma when electrical current is applied to the air discharge wireframe. The plasma can then flow past a positive porous ion capture mesh 42. The positive ions collect on the mesh leaving negative ions 43 in the airflow. The negative ions have a negative charge 38 and can be monitored using a plasma sensor 47 which can sense air speed, temperature and pressure at the negative ion flow. The electron flow capture plate 40 captures the negative ions producing an electrical difference. A transformer 45 after the electron flow capture plate 40 can power the air discharge wireframe 34. An airflow exit sensor 45 can sense an air speed, temperature and pressure at the airflow exit to produce airflow exit data that is sent to the controller 48 for optimizing the controller 48.

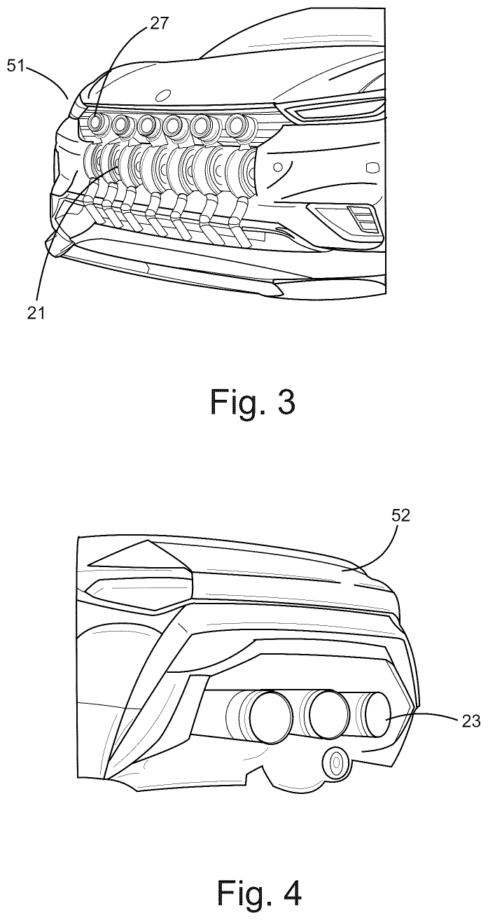

As seen in FIG. 3, a vehicle front portion can have funnel openings receiving an air intake. The air inlet funnel 27 receives an airflow from the vehicle front 51. The air inlet funnel 27 can also be paired with an air intake opening 21. Dampers can cover the air inlet funnels when electrical generation is not needed.

As seen in FIG. 4, a vehicle rear portion 52 can have air openings with an air outlet. Thus, the airflow passes through the vehicle and exits from the airflow exit 23.

A second method of generating electricity from the airflow is by harvesting the electromagnetic induction by first generating plasma and then accelerating the plasma past a conductor. The resulting induction that occurs produces electricity. The second method is the best mode and is thought to be more efficient than the first method of proton recombination.

The second method has the steps of first creating the plasma through thin wire gaps, then decreasing the discharge energy needed and the flow decreases the dielectric strength making it easier to generate high plasma density. The plasma induction current in the wires is a hollow core induction. The current flows through the wires. The wires are arranged in a coil. The wire coil can be helical and surround the airflow that passes through the center of the wire coil. The inductor current section can be about 2 feet long.

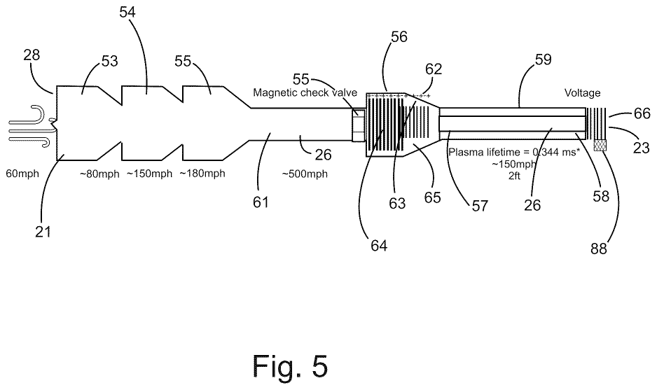

As seen in FIG. 5, in shorter tube length and plasma lifetime systems, a 2 foot one-inch tube section for plasma acceleration can accelerate air flow from 60 miles per hour to 150 miles per hour. The air intake accelerator can accelerate air in stages such as by intake funnels such as successively smaller cross-section funnels. After the air intake accelerator, a magnetic check valve opens a plasma generation unit that receives airflow at 500 miles per hour. The plasma lifetime can be about 5-8 milliseconds. The inductor current section generates a power output of between 36 kilowatts and 110 kilowatts when about 2 feet long and connected to the plasma generator. A controller can control the plasma generation unit, the air intake accelerator, and inductor current based on calculations derived from temperature, electrostatic, pressure, and airflow sensors mounted in the air intake funnel.

A controller such as an electronic controller can use rough calculations to estimate plasma density entering the inductor. For example, sensor variables can provide data at pressure driving plasma out being 20-25 pounds per square inch with an absolute pressure of around 34.7-39.7 psi and the temperature range for the plasma is around 1-2 eV at 11,000-22,000 Kelvin and an ionization degree estimated high at greater than >90% due to efficient plasma generation. A plasma density calculation can yield approximately 10\hat{ }16 to 10\hat{ }17 particles per cubic meter (ions+free electrons) or more specifically: 10\hat{ }16 particles/m\hat{ }3=6.24×10\hat{ }12 particles/cm\hat{ }3 to 10\hat{ }17 particles/m\hat{ }3=6.24×10\hat{ }13 particles/cm\hat{ }3.

The controller may also have a plasma lifetime estimation algorithm configured for sensing a status inside the hollow core inductor and analyzing factors influencing lifetime. For example, a variety of different sensors can measure collisional recombination, diffusion out of inductor, and given inductor dimensions for example 1 inch diameter at 2 feet long, the estimated plasma lifetime inside the inductor can be approximated at 10-50 microseconds using engineering mathematics configured on the controller estimation algorithm. The algorithm may have maximum and minimum values based on research such as research that suggests plasma in magnetic fields can survive up to 100-200 microseconds.

The controller can estimate plasma flow by measuring voltage. For example, both plasma flow and voltage can be proportional to each other and the controller can have an algorithm based on modeling of plasma flowing past a wire for inducing voltage due to electromagnetic induction and electrostatic charging. The voltage calculation accounts for wire diameter which affects voltage magnitude. The controller can estimate voltage induced per wire such as by measuring plasma velocity which could be 265 feet per second, measuring plasma density which could be 10\hat{ }16 to 10\hat{ }17 particles/m\hat{ }3 and accounting for a wire diameter which could be 0.643 mm (22 gauge). The controller can estimate induced voltage per wire which can be approximately 100-300 volts per millimeter of wire length exposed to plasma.

Since plasma flows past an entire length near wire surface the estimate can use a lower estimate for flow past scenario such as if approximately 50-150 volts per wire are generated. The estimate can have bounds based on some research which suggests up to 200 volts per millimeter for plasma flow past wire at high velocity. Therefore, for example for 10 wires in parallel assuming all are the same length and exposed to plasma a total estimated induced voltage can be approximately 500-1500 volts. Considering other factors such as wire insulation breakdown and plasma variability, an expected 1000 volts seems achievable with 10 wires. To increase confidence in reaching 1000 volts, the airflow air intake can be increased in length with a corresponding increase in wire length exposed to plasma, or the device can incorporate more wires such as increasing the number of wires to 12-15 wires in parallel instead of 10, or the airflow intake can optimize the plasma flow velocity or density near the wires.

The controller can receive the operational data from the sensors and the operational data can be stored on a data storage. The controller can also query the data storage to optimize operations and control the plasma generation and magnetic check valve. The controller can also close the air intake for optimizing aerodynamics when full plasma generation is not necessary or can be throttled. Optionally, the ion capture first embodiment can be combined with the plasma induction embodiment for both ion capture and plasma induction electrical generation.

The air inlet damper 28 controlled by the controller can open to expose the air intake opening 21. A first funnel section 53 can increase airspeed from 60 miles an hour up to 80 miles an hour. The second funnel section 54 can increase airspeed from 80 miles an hour up to 180 miles an hour. The third funnel section 55 can increase airspeed from 150 miles an hour up to 500 miles an hour in a high-speed airflow section 61.

The controller can also control the magnetic check valve 155 to open and close the airflow 26. The plasma generator 56 can have a plasma generation matrix 64 which may include positive charge elements such as positive charge wires 62 and negative charge elements such as negative charge wires 63. The positive and negative charge wires can arc and produce a plasma. The plasma stream 57 passes through an induction chamber 59. The induction chamber 59 has a voltage and the voltage can be induced in induction wire elements 58. The induction wire elements 58 can be formed as wires that are parallel to the airflow 26. The airflow exit conductor 66 can receive a voltage from the induction wire elements 58 that are in the plasma airflow. The preferred length of the induction chamber 59 is two feet when the plasma lifetime is 0.344 ms at an airflow of 150 mi./h. Energy generated from the induction chamber 59 can power the plasma generator 56 and additionally produce a surplus of energy that can be harnessed for other vehicle operations such as regenerative power to vehicle batteries such as in an electrical vehicle such as a battery 88.

1. A kinetic energy harvesting system comprising:
a. an air intake accelerator, wherein the air intake accelerator is formed as a funnel
which receives an airflow;
b. a plasma generator, wherein the plasma generator receives the airflow from the air intake accelerator and generates a plasma flow; and
c. an inductor current section, wherein the inductor current generates electricity from the plasma flow.

2. The kinetic energy harvesting system of claim 1, wherein the sensor system further includes a plasma sensor, wherein the plasma sensor senses a speed and temperature of the plasma flow.

3. The kinetic energy harvesting system of claim 1, wherein the inductor current section further includes multiple metal wires mounted in the plasma flow, wherein the multiple metal wires generate induction electricity from the plasma flow.

4. The kinetic energy harvesting system of claim 3, wherein the multiple metal wires are parallel to the plasma flow.

5. The kinetic energy harvesting system of claim 1, wherein the air intake accelerator has a magnetic.

6. The kinetic energy harvesting system of claim 1, further including a controller and a sensor system, wherein the controller and controls the plasma generator, wherein the sensor system senses a speed of the plasma flow and temperature in the inductor current section.

7. The kinetic energy harvesting system of claim 2, wherein the sensor system includes an air intake sensor and an air outlet sensor, wherein the air intake sensor senses an intake air flow speed and an intake air flow temperature, wherein the air outlet sensor senses an outlet airflow speed and an outlet airflow temperature.

8. The kinetic energy harvesting system of claim 1, wherein the plasma generator has a plasma generation matrix formed from a plurality of negative charge elements and positive charge elements that are charged to produce plasma.

9. The kinetic energy harvesting system of claim 8, wherein the sensor system further includes a plasma sensor, wherein the plasma sensor senses a speed and temperature of the plasma flow.

10. The kinetic energy harvesting system of claim 8, wherein the inductor current section further includes multiple metal wires mounted in the plasma flow, wherein the multiple metal wires generate induction electricity from the plasma flow.

11. The kinetic energy harvesting system of claim 10, wherein the multiple metal wires are parallel to the plasma flow.

12. The kinetic energy harvesting system of claim 8, wherein the air intake accelerator has a magnetic.

13. The kinetic energy harvesting system of claim 8, further including a controller and a sensor system, wherein the controller and controls the plasma generator, wherein the sensor system senses a speed of the plasma flow and temperature in the inductor current section.

14. The kinetic energy harvesting system of claim 13, wherein the sensor system includes an air intake sensor and an air outlet sensor, wherein the air intake sensor senses an intake air flow speed and an intake air flow temperature, wherein the air outlet sensor senses an outlet airflow speed and an outlet airflow temperature.
